(19) United States
(12) Patent Application Publication
(10) Pub. No.: US 2007/0115680 A1
(43) Pub. Date: May 24, 2007

(54) Third back up light

(76) Inventors: Chin-Lung Tsai, Taichung City (TW); Chun-Jung Liao, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/284,827

(22) Filed: Nov. 23, 2005

(51) Int. Cl. F21V 29/00

(52) U.S. Cl. 362/544

(57) ABSTRACT

A third back-up light for vehicles is disclosed. A back-up indicating light of the present invention is disposed on corners or lateral area of a rear lamp set, and works synchronously with the original back-up light so as to enhance insufficient warning effect of the original back-up light of the rear lamp set as well as increase visible angle or warning area of the back-up light. Moreover, the third back-up light is integrated with the rear lamp set without influence on original function of the rear lamp set. Thus the assembling of the present invention is finished at the same time with the assembling of the rear lamp set so as to become a general specification for the rear lamp set. Furthermore, the third back up light can emit white light, light with other colors, or blinking light, all achieve the warning effect.

### BACKGROUND OF THE INVENTION

The present invention relates to a third back-up light, especially to a back-up indicating light disposed on corners or lateral area of the rear lamp set, and integrated with a tail light that acts synchronously with the original back-up light so as to increase safety and convenience for reversing.

Refer to FIG. 1 & FIG. 2, a rear lamp set 2 is disposed on right and left sides of the tail 11 of automobiles 1 respectively. The light source of the rear lamp set 2 can be light bulbs or LED(light-emitting diode) light and the design of the rear lamp set 2 is various. The rear lamp set 2 consists of a tail lamp (or a stop & tail lamp) 21, a rear turn signal lamp 22 and a back up lamp 23. Although there are various designs of the car body, the rear lamp set 2 generally includes a tail lamp or stop & tail lamp 21, a rear turn signal lamp 22, and a back-up lamp 23. The rear lamp set 2 can be a single-part type (in FIG. 1 ) or a two-part type, as shown in FIG.2. The rear lamp set 2 consists of two separated parts. The rear turn signal lamp 22 integrated with stop & tail lamp 21 is disposed on right/left sides of a car tail, extending over the two corners 14 on the car tail to the lateral side 15. Thus the tail lamp 21 can be seen from lateral side of vehicles. And the back up lamp 23 is arranged on right/left sides of a trunk lid 12. Moreover, the rear lamp set 2 is composed by a transparent housing, an inner base, light source and wires. Furthermore, a conventional high mount stop lamp Set 6 disposed on a rear window 13 can also be included into the rear lamp set 2. The high mount stop lamp set 6 is a one-piece part, arranged on or beneath the rear window 13 for assisting indication function of the stop & tail lamp 21.

The back up lamp 23 of the rear lamp set 2 is always disposed on middle part of the car tail 11 and is lightening for warning while the car is reversing. However, most of the light from the back up lamp 23 emits backwards so that the visible angle is quite narrow and the warning effect is insufficient. Vehicles or people see the light from the back up lamp 23 only when they are quite near the rear side of vehicles. Thus it is dangerous and inconvenient while reversing vehicles. For example, on parking area that the car tail faces a lane, drivers on the lane can't find that the car on the parking area is reversing in time due to narrow range of the back-up light. The two cars may collide and the car accident happens. Thus there is a need to improve warning effect for back-up light.

### SUMMARY OF THE INVENTION

It is therefore a primary object of the present invention to provide a third back up light that is added on corners or lateral extension area of a rear lamp set structure of vehicles and works synchronously with original back up light so as to enhance insufficient warning effect of the original back up light of the rear lamp set and increase visible angle as well as warning area of the back up light. Thus the safety and convenience for reversing vehicles are improved.

It is another object of the present invention to provide a third back up light that is disposed directly on structure of the rear lamp set and the third back up light is assembled as well as integrated with the rear lamp set. Thus the assembling of the third back up light is finished at the same time with the assembling of the rear lamp set. The device is easy to be assembled and is attached with the rear lamp set to form a general specification for the rear lamp set.

It is a further object of the present invention to provide a third back up light that provides a back-up indicating light disposed on an accommodation slot between an inner base and a transparent cover of the rear lamp set, located on corners or lateral extension area thereof. The addition of the back-up indicating light won't affect original function of the rear lamp set.

It is a further object of the present invention to provide a third back up light that emits white light-the same with the light of original back-up light , light with other colors, or blinking light so as to enhance warning effect for reversing.

### BRIEF DESCRIPTION OF THE DRAWINGS

FIG. 1 is a schematic drawing of a conventional single-part rear lamp set for vehicles;

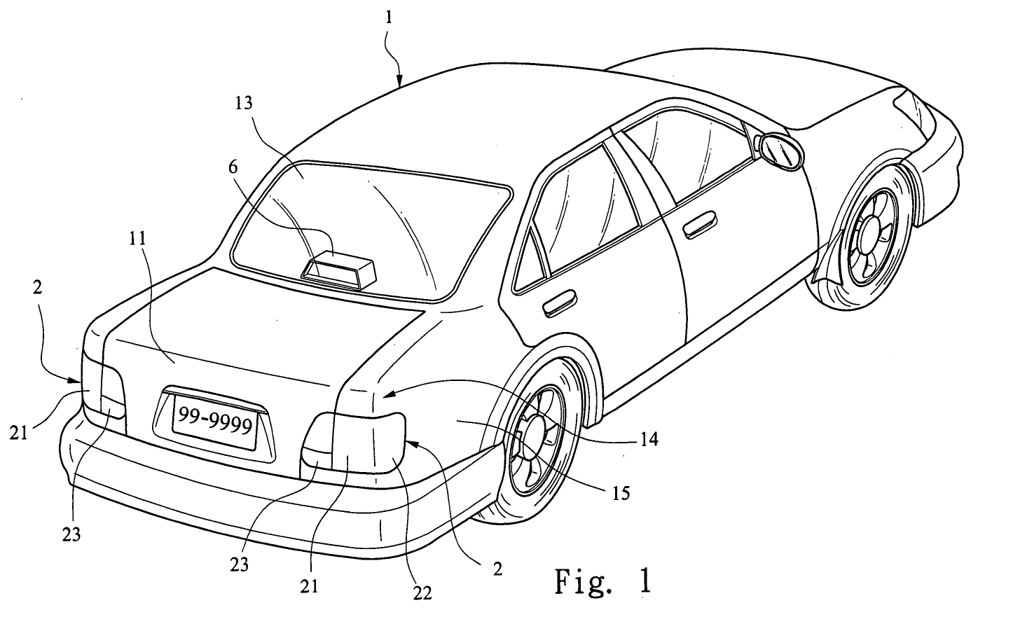

FIG. 2 is a schematic drawing of a conventional two-part rear lamp set for vehicles;

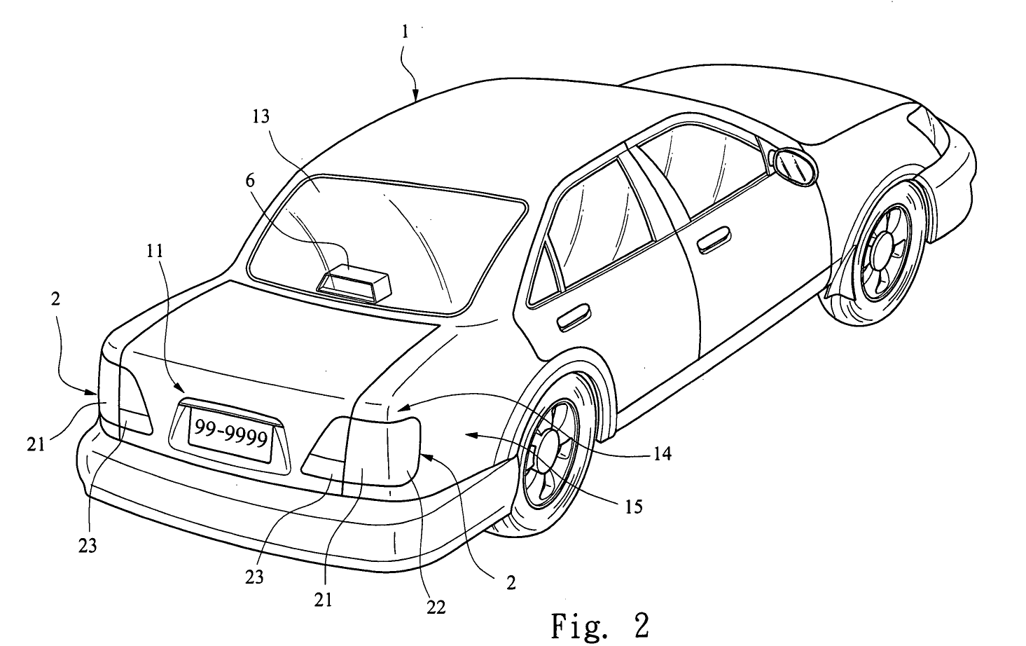

FIG. 3 is a schematic drawing showing a single-part rear lamp set for vehicles in accordance with the present invention in usage;

FIG. 4 is a schematic drawing showing a two-part rear lamp set for vehicles in accordance with the present invention in usage;

FIG. 5 is a schematic drawing of an embodiment in accordance with the present invention;

FIG. 6 is a top view of the embodiment in FIG. 5;

FIG. 7 is a schematic drawing showing that an embodiment of the present invention is applied to a high mount stop lamp set.

### DETAILED DESCRIPTION OF THE PREFERRED EMBODIMENT

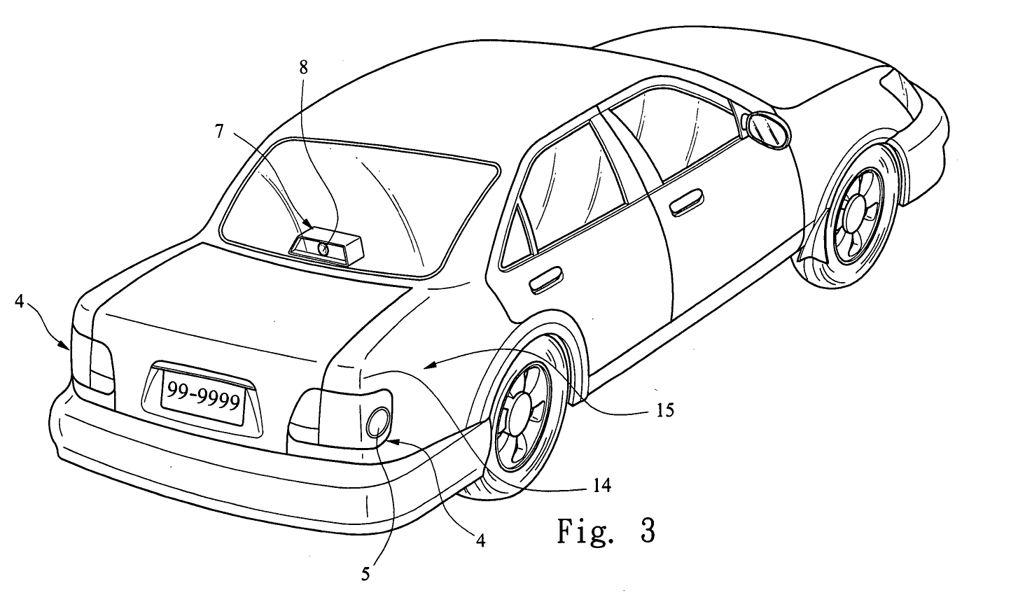

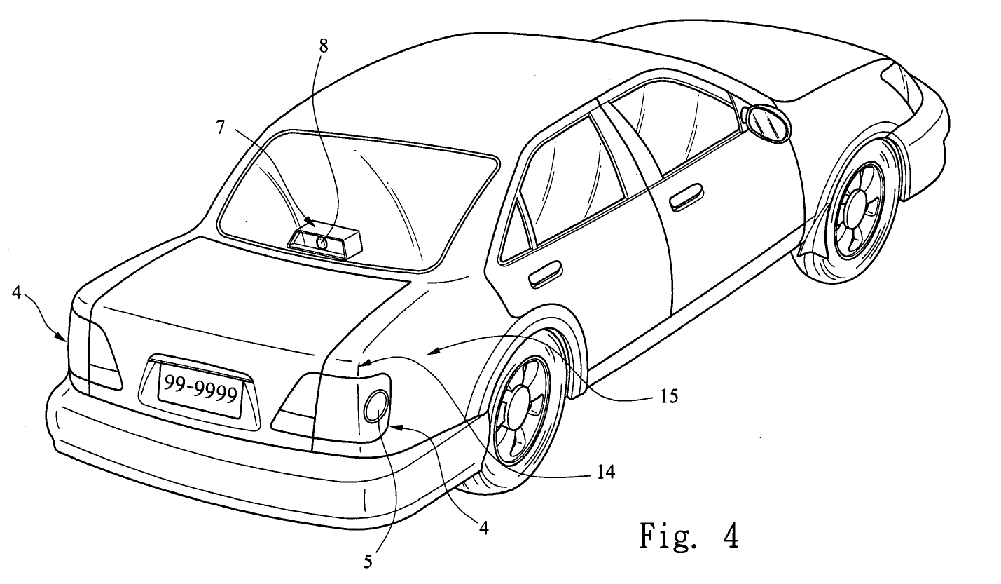

Refer from FIG. 3 to FIG. 6, the present invention features on that a back-up indicating light 5 is disposed on corners or lateral extension area of a rear lamp set 4 structure. No matter the rear lamp set 4 is a single-part type shown in FIG. 3 or a two-part type shown in FIG. 4, the back-up indicating light 5 is integrated with the part it disposed to form a structure.

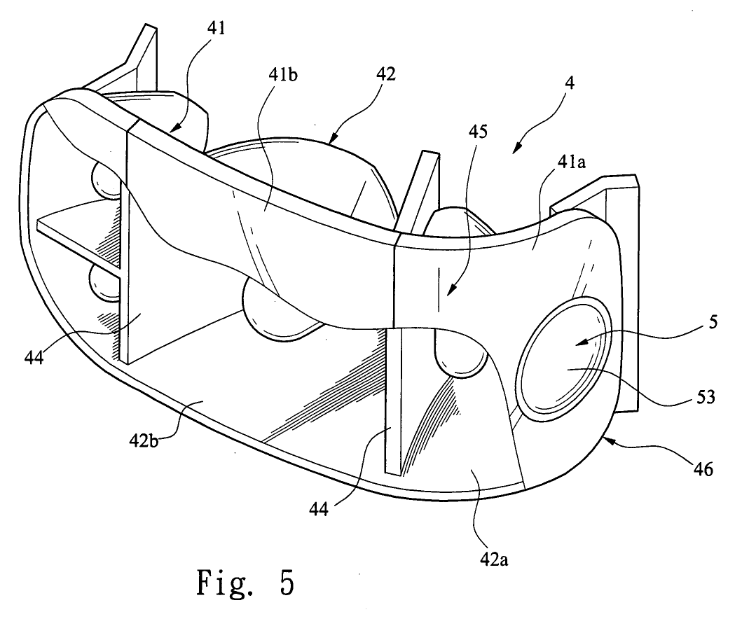

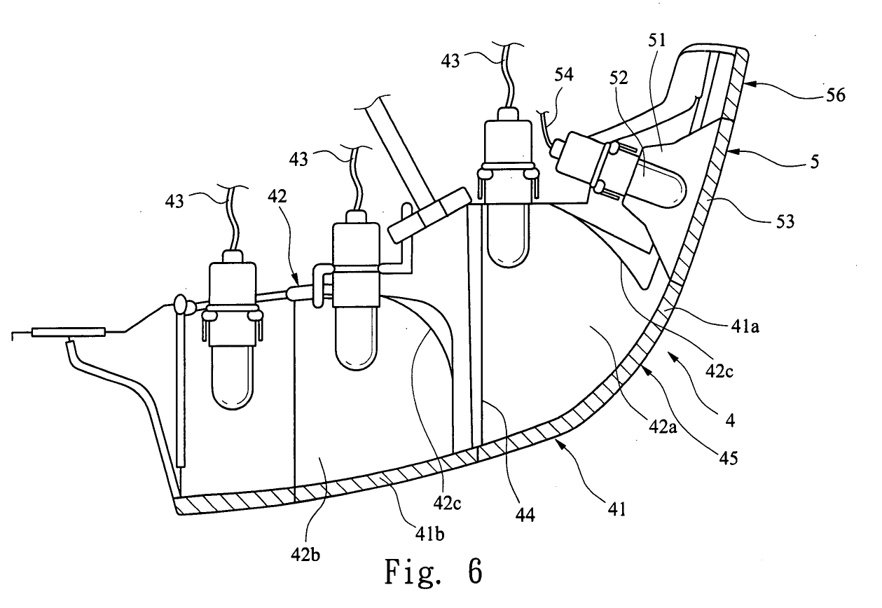

Light source of the rear lamp set available now can be light bulbs or light-emitting diode (LED) lights. The present invention can be applied to the rear lamp set with light bulbs or LED lights. Take the rear lamp set 4 in FIG. 5 & FIG. 6 as an example, the rear lamp set 4 consists of a transparent cover 41, an inner base 42 and control wires 43. The transparent cover 41 includes areas with various functions such as turn signal lamp area 41a, or brake light area 41b. The inner base 42 has lamp holders and light bulbs. Corresponding to various areas of the transparent cover 41, inner space of the inner base 42 is divided into a plurality of accommodation slots 42a, 42b for convenience of assembling various areas. As shown in FIG. 5 & FIG. 6, the accommodation slot 42a corresponds to the turn signal lamp area 41a while another accommodation slot 42b corresponds to the brake light area 41b. A partition plate 44 is located between the two accommodation slots 42a, 42b. A concave mirror 42c is disposed on each of the accommodation slots 42a, 42b for reflecting and converging light so that light from each light source in different areas emits separately. The present invention features on that a back-up indicating light 5 acting as a third back-up light is added on corner area 45 or lateral extension area 46 of the rear lamp set 4. Thus the warning effect of the back-up indicating light 5 is extended to the position of two corners on the car tail 14 or car sides 15 so that the back-up indicating light 5 can be seen from lager area of the rear side of the vehicles.

Refer to FIG. 6, an accommodation slot 51 with proper size is arranged between the transparent cover 41 and the inner base 42 for installment of a light source 52 providing light for back-up that can be a light bulb or a LED. Corresponding to the light source 52, a back-up light area 53 is on the transparent cover 41 so as to make the light source 52 project white light outwards through the back-up light area 53. The back-up indicating light 5 includes the accommodation slot 51, the light source 52 and the back-up light area 53. The disposition of the back-up indicating light 5 has no influence on indications of other areas such as turn signal lamp area 41a, or brake light area 41b on the rear lamp set 4. Moreover, the accommodation slot 51 is installed in similar way of the accommodation slots 42a, 42b. Furthermore, wires 54 of the back-up indicating light 5 is connected with original control wires (not shown in figure) of the back-up light in the rear lamp set 4 so as to make the assembling of the back-up indicating light 5 finish at the same time with the assembling of the rear lamp set 4 and the back-up indicating light 5 works synchronously with the original back-up light.

In practice, the back-up indicating light 5 is disposed on the corners 45 or the lateral extension area 46 of the rear lamp set 4 and the position varies in accordance with the inner structure, design or type of the light source such as light bulb or led. Basically, the visible angle of the back-up indicating light 5 is enlarged into large area behind the vehicles once the back-up indicating light 5 is inside the corners 45 or the lateral extension area 46 so as to enhance the insufficient warning effect of the rear lamp set 4. Moreover, the visible angle as well as waning area of the back-up light for vehicles is increased and the back-up indicating light 5 works as a third back-up light, just like the high mount stop lamp set.

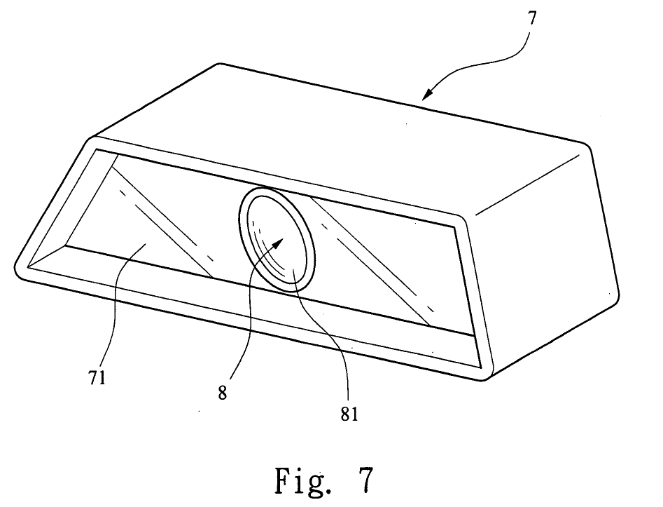

Refer to FIG. 3, FIG. 4 & FIG. 7, a high mount stop lamp set 7 basically includes parts such as a transparent cover 71, an inner base and control wires (not shown in figure). The present invention having a back-up light 8 disposed on the high mount stop lamp set 7. The back-up light 8 is preferably arranged on middle part of the transparent cover 71. The disposition way of the back-up light 8 on the high mount stop lamp set 7 is similar to the arrangement of the back-up indicating light 5 on the rear lamp set 4. The light source of the back-up light 8 and the high mount stop lamp set 7 can be light bulbs or LED. Moreover, a back-up area 81 is arranged on the transparent cover 71, corresponding to the back-up light 8, so that the light from the back-up light 8 is projected outwards just like white light of general back-up lights. Furthermore, wires of the back-up light 8 connect with control wires (not shown in figure) of original back-up lights of the rear lamp set 4 for synchronous action with the original back-up light. The above-mentioned high mount stop lamp set 7 with the back-up light 8 and the back-up area 81 is especially suitable for vehicles without trunk lid on tail part such as five door vehicles or caravans because the high mount stop lamp set 7 has functions of both back-up indication and warning effect.

The above-mentioned third back-up indicating light 5 or 8 can emit the same white light of the original back-up light, light with other colors, or blinking light for enhancing warning effect while reversing vehicles.

In accordance with the above design, the present invention has following effects:

[1]The back-up lights 5, 8 have larger visible angle and better warning effect so as to enhance warning effect of the original back-up light in the rear lamp set and work as a third back-up light, similar to the high mount stop lamp.

[2]The back-up lights 5, 8 are manufactured and assembled with the rear lamp set 4 or the high mount stop lamp set 7. They works synchronously with original back-up light of the rear lamp set 4 without any influence on function of the rear lamp set 4. Thus the manufacturing and assembling processes are simplified.

[3]Due to integrated manufacturing and easy assembling, the third back up lights 5, 8 is getting popular and the safety as well as convenience of reversing is improved.

What is claimed is:

1. A third back up light disposed on a rear lamp set of vehicles; the rear lamp set having a tail lamp or a stop & tail lamp, a rear turn signal lamp and a back up lamp is a one-part type or two-part type while the part comprising a transparent housing, an inner base, a light source and wires; the third back up light is characterized in that: the third back up light is disposed on corners or lateral extension area of the rear lamp set and is electrically connected with the original back up light of the rear lamp set so as to work synchronously with the original back up light.

2. The light as claimed in claim 1, wherein the third back up light is a light bulb or light-emitting diode (LED).

3. The light as claimed in claim 1, wherein an accommodation slot with proper size is arranged between the transparent cover and the inner base of the rear lamp set for installment of a light source providing light for back-up and a back-up light area corresponding to the light source is on the transparent cover so as to make the light source project light outwards through the back-up light area.

4. The light as claimed in claim 3, wherein an optical structure for assembling with the light source is arranged in the accommodation slot.

5. The light as claimed in claim 1, wherein the rear lamp set further having a high mount stop lamp set on rear window of vehicles; the high mount stop lamp set having a transparent cover, an inner base, a light source and control wires; the third back up light is disposed on the high mount stop lamp set and is electrically connected with original back up lights of the rear lamp set so as to work synchronously with the original back up lights.

6. The light as claimed in claim 5, wherein the third back up light is preferably disposed on middle part of the transparent cover of the high mount stop lamp set.

7. The light as claimed in claim 5, wherein an accommodation slot with proper size is arranged between the transparent cover and the inner base of the high mount stop lamp set for installment of a light source providing light for back-up and a back-up light area corresponding to the light source is on the transparent cover so as to make the light source project light outwards through the back-up light area.
